(19) United States
(12) Patent Application Publication
(10) Pub. No.: US 2002/0008625 A1
(43) Pub. Date: Jan. 24, 2002

(54) Remote accountability system and method

(76) Inventors: Jonathan D. Adams, Shaker Heights, OH (US); Joseph Birli, Munson, OH (US); Gary Claypoole, West Chester, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/794,756

(22) Filed: Feb. 27, 2001

Related U.S. Application Data
(60) Provisional application No. 60/186,074, filed on Feb. 29, 2000.

(51) Int. Cl. G08B 23/00

(52) U.S. Cl. 340/573.1; 340/540

(57) ABSTRACT

A self-contained breathing apparatus (SCBA) based accountability system is provided. The system includes at least one communication module affixed to the SCBA. The communication module includes, for example, an electronic key port configured to accept an electronic key device having identification information, at least one sensor port for interfacing with at least one sensor system, and a controller in circuit communication with said electronic key port. The communication module reads, stores, and transmits the identification information to a command post for remote monitoring. The communication module also transmits data received through the sensor port to the command post. The sensor system that interfaces with the communication module can include a wide variety of sensors including, for example, a pressure sensor for sensing pressure from the breathing gas tank of the SCBA. Other Insensors include temperature, gas, and physiological sensors.

This application claims the benefit of U.S. Provisional Application No. 60/186,074, filed Feb. 29, 2000, which is hereby fully incorporated by reference.

### FIELD OF THE INVENTION

The invention relates generally to communication systems, and more particularly, to a method and system for communicating information between one or more remote portable accountability systems and one or more command systems.

### BACKGROUND OF THE INVENTION

Many emergency situations such as, for example, fire fighting, require effective communications between the individuals responding to the emergency and a command or control center. However, present systems suffer from the disadvantage of providing only limited accountability information between the individuals responding to the emergency and the command and control center. Hence, there is a need for a robust accountability communication system that provides both the individuals responding to the emergency and the command and control center with information that may be vital to the safety of the individuals involved and the prosecution and resolution of the emergency.

### SUMMARY OF THE INVENTION

The present invention provides a method and system having two-way messaging and a means for tracking personnel status by establishing wireless links between one or more mobile persons (portables) and a command post system. It is designed to improve the safety and efficiency of, for example, fire teams working in hazardous environments.

The system has one or more “portables” worn by one of more mobile workers and a command post system. Each portable is comprised of a small “black box” containing a radio transceiver, control circuitry, optional data communication ports, antenna and optional power source. The portable is preferably attached or otherwise affixed to a self-contained breathing apparatus (SCBA). These portable units communicate via radio frequency with a command post system. The command post system includes a base station radio with a display and a data communications port allowing connection to a Personal Computer for data downloading or real-time display of data.

The system preferably utilizes a polling radio network architecture providing robust two-way communications between the mobile portable units and the command post system. Improved radio link range and reliability are provided and the present invention seeks to maximize these features and to immediately alert users at both ends of the link in the event of an out-of-range condition. To maximize link range and reliability, the present invention employs robust link protocol that enhances acquisition, maintenance and re-acquisition of data in the event of momentary loss. This protocol provides for successful data transmission in situations where voice radio communications may be garbled. Critical messages such as evacuation alarms are continually re-sent until receipt is acknowledged. The command post system preferably supports up to 50 portable units.

Another preferable approach expand the system polling architecture to include a packet-mode when a mobile portable unit has been out of range for a predetermined period of time. This additional mode allows an out of range mobile portable unit to relay its information to another mobile portable unit, which is in range of the base station or command post. When a mobile portable unit has not received an inquiry from the base station or command post for a predetermined period of time, it will monitor the traffic present on its communication channel. This portable unit will then search for another mobile portable unit that is in range and forward its data to the base station or command post via the in-range portable unit. The base station or command post then communicates with the out of range mobile portable unit using this packet-mode relay approach until the out of range mobile portable unit can again communicate directly with the base station or command post.

System software and control circuits provide flexibility in choice of radio communication by having software programmable radio frequencies. This provides an easy migration to a different radio module (e.g., different frequency, data rate, and/or modulation technique) in the event of regulatory changes or if the system is to be used where radio spectrum changes would be required. The present invention preferably transmits signals in the ultra-high frequency (UHF) range and, most preferably, in the approximate range of 450 to 460 MHz.

Each portable unit has a unique digital address allowing for multiple portable units on a single radio network. The system of the present invention is particularly useful at fire scenes where multiple systems can be operating. This is possible because each system operates on its own frequency. Additional channels could be added to provide a “universal” channel if it is desirable to have firefighters from different departments operating from a single command post radio. The portable units can also be initialized via a personal key/tag or other device to carry personal identification and other information about the individual that will be automatically transmitted to the command post system.

Each portable is capable of receiving and transmitting a plurality of accountability information. For example, accountability information that can be transmitted from a portable includes video and audio information, external temperature, physiological characteristics, external pressure, SCBA status (i.e., air or time remaining), emergency signals, motion information, hazardous gases in the environment, and personal information.

Therefore, it is an advantage of the present invention to provide a SCBA-based portable unit for communicating accountability information to a command system.

It is another advantage of the present invention to provide an easily configurable portable unit that can be quickly programmed with personal information and unique identification information.

It is another advantage of the present invention to provide a robust communication protocol between one or more portables and a command system so as to maintain a constant communication link between the portables and the command system.

These and other advantages will be apparent from the below detailed description and drawing figures.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to demonstrate the principles of this invention.

FIGS. 1A, 1B, 1C, and 1D are block diagrams illustrating various embodiments of the system of the present invention.

FIG. 2 is a block diagram illustrating certain components of a command post system of the present invention.

FIG. 3 is a block diagram illustrating certain components of a repeater unit of the present invention.

FIG. 4A is a block diagram illustrating certain components of a portable unit and sensor system of the present invention.

FIG. 4B is a diagram illustrating the general location of a portable unit and sensor system of the present invention in relation to the components of a Self-Contained Breathing Apparatus (SCBA).

FIG. 5 is a flowchart illustrating the logic flow of the present invention.

FIG. 6 is a diagram illustrating a portion of a display generated by the present invention.

FIG. 7 is a flowchart further illustrating the logic flow of the present invention.

### DETAILED DESCRIPTION OF THE INVENTION

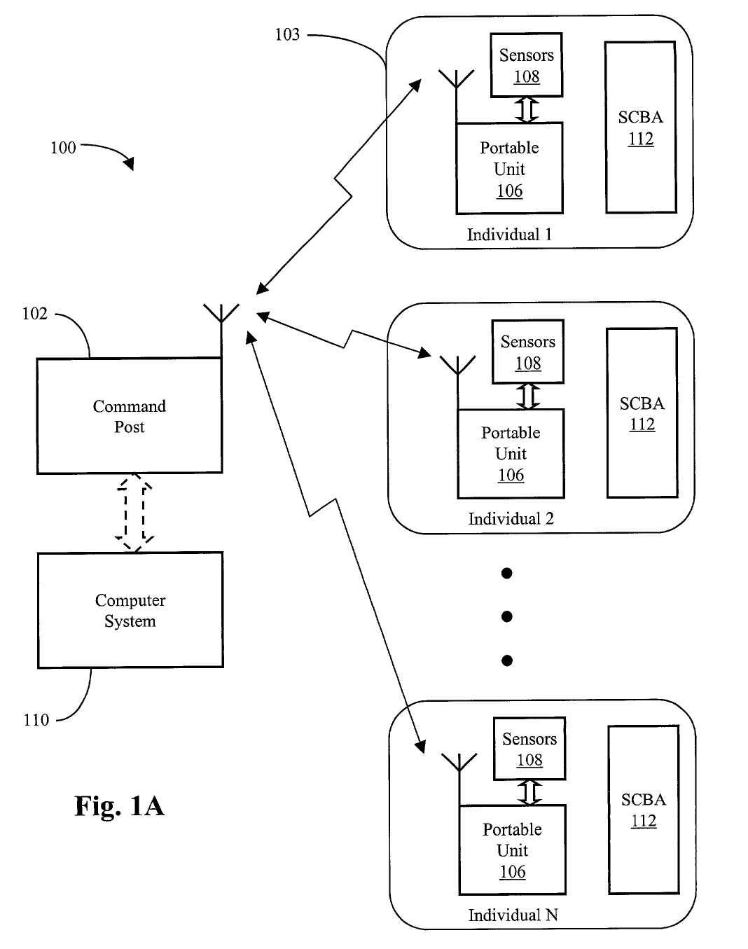

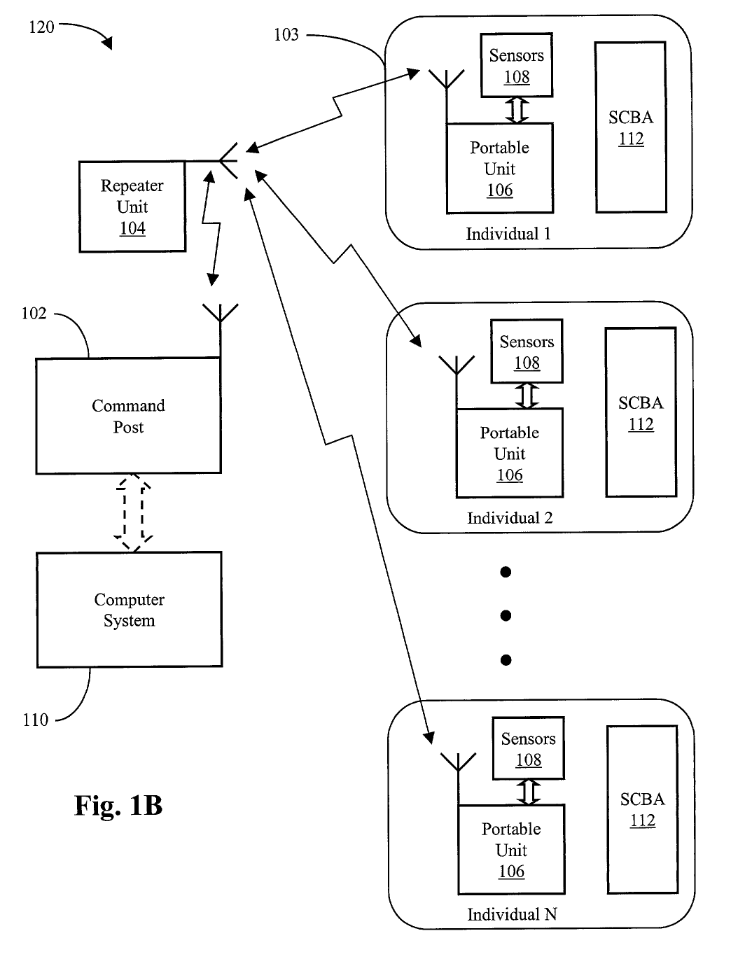

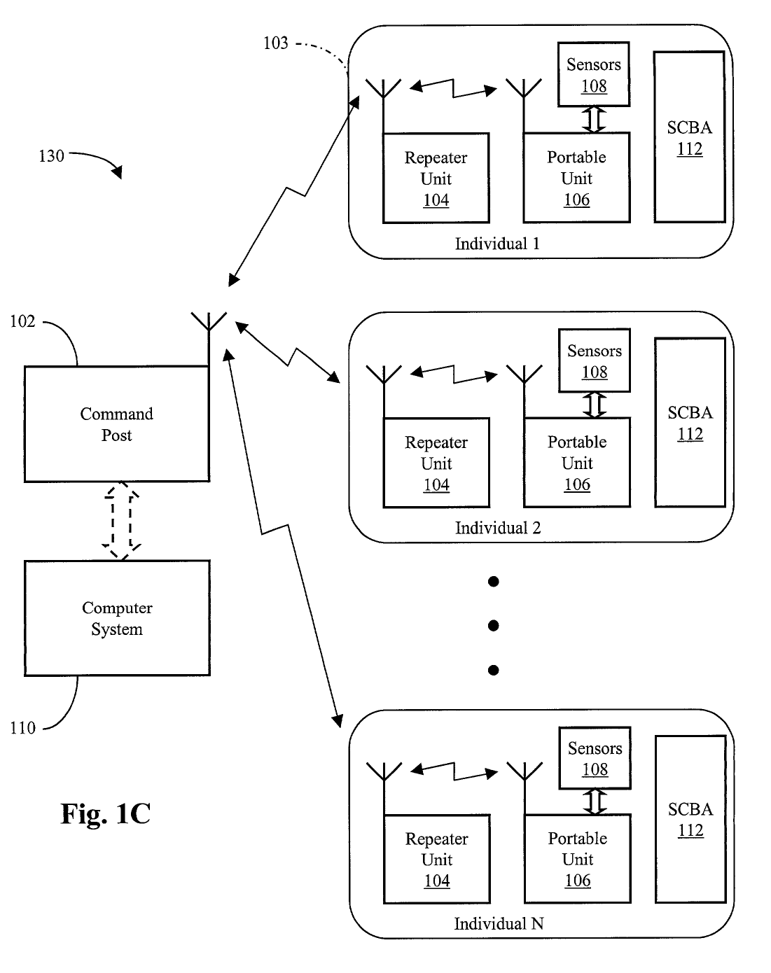

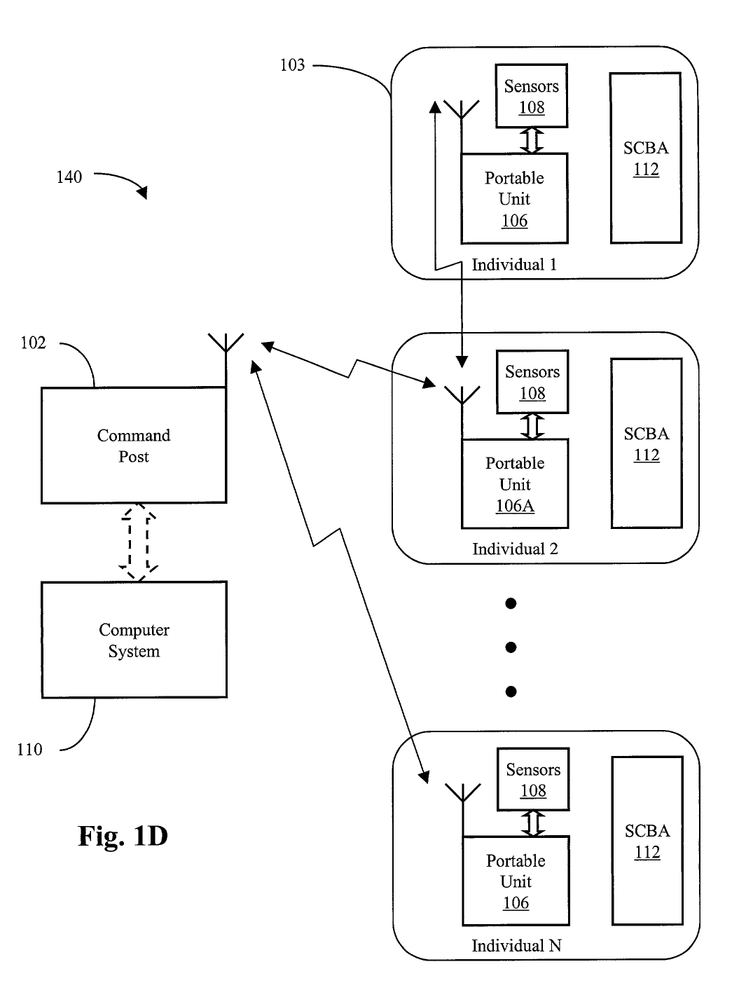

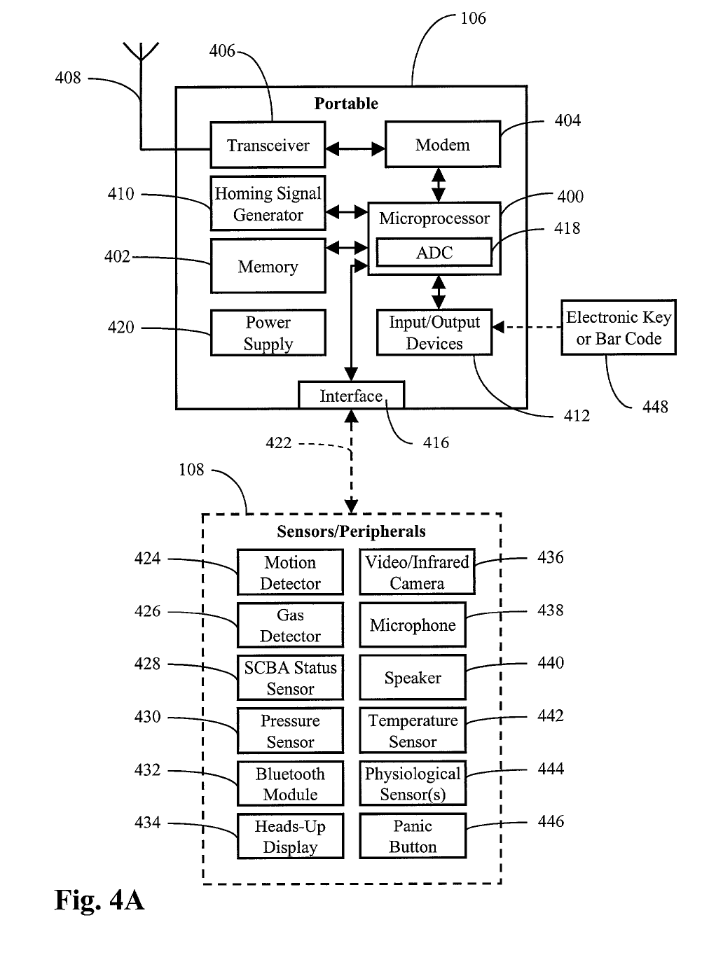

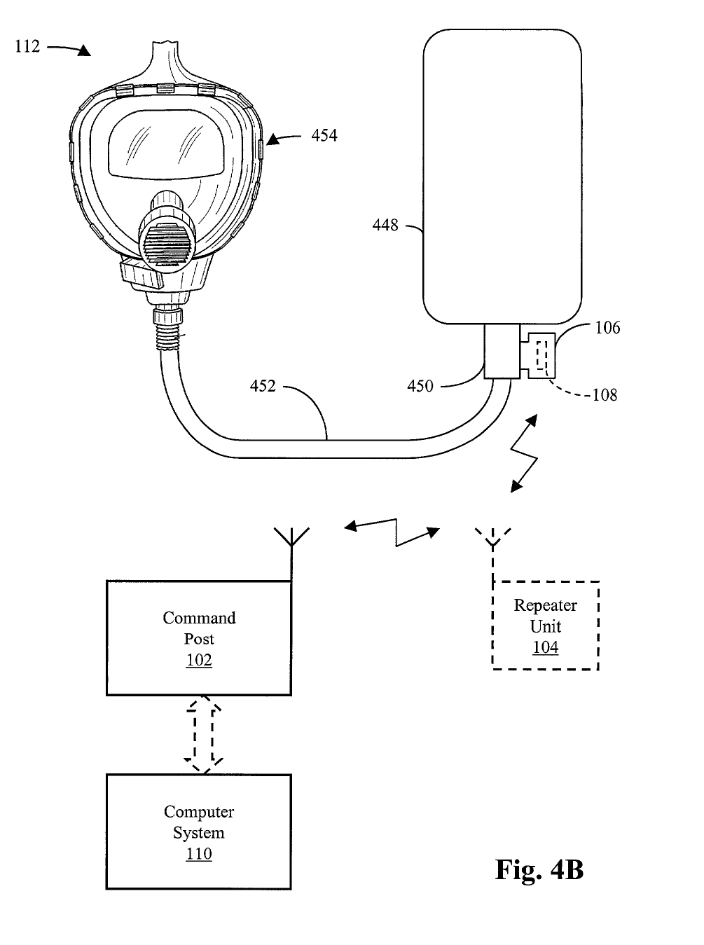

Referring now the drawings and particularly to FIG. 1A, a first embodiment of the present invention embodied by system 100 is shown. The system 100 has at least one command post system 102 and at least one portable remote system 103. In general, data is collected from sensor system(s) 108 by portable unit 106 and transmitted to command post system 102. The nature of the data can be diverse, depending the specific application of the system. For example, in a chemical factory, it may be useful to transmit readings from a portable gas detector. If levels of certain gases reach an unsafe level, a supervisor can evacuate workers. In a fire fighting scenario, ambient environmental temperature and remaining air tank levels may be of more interest. In a combat setting, it might be desirable to transmit physiological data from soldiers. Other examples and descriptions of transmittable data and information will be described in more detail in connection with the description of FIG. 4A.

The portable remote system 103 is preferably worn by an individual such as, for example, a firefighter on a self-contained breathing apparatus (SCBA) 112. Generally, there are N portable remote systems, where N is based on the number of individuals wearing the system. The portable remote system 103 preferably includes a portable unit 106 and, optionally, one or more sensor systems 108. In FIG. 1A, the portable unit 106 communicates directly with command post system 102 via a radio-frequency (hereinafter RF) communication channel.

The command post system 102 is designed as a stand-alone system. However, it can be optionally connected to a computer system 110 such as, for example, a personal computer system or laptop or notebook computer system. The computer system 110 preferably includes one or more input/output devices such as, for example, displays, keyboards, touch pad, mouse, pointing stick, microphone, etc. The connection between command post system 102 and computer system 110 is preferably hardwired through serial, parallel, or RS-232 interfaces. Alternatively, the connection can via RF or infrared signal in situations where a hardwired connection proves impractical or too difficult to achieve.

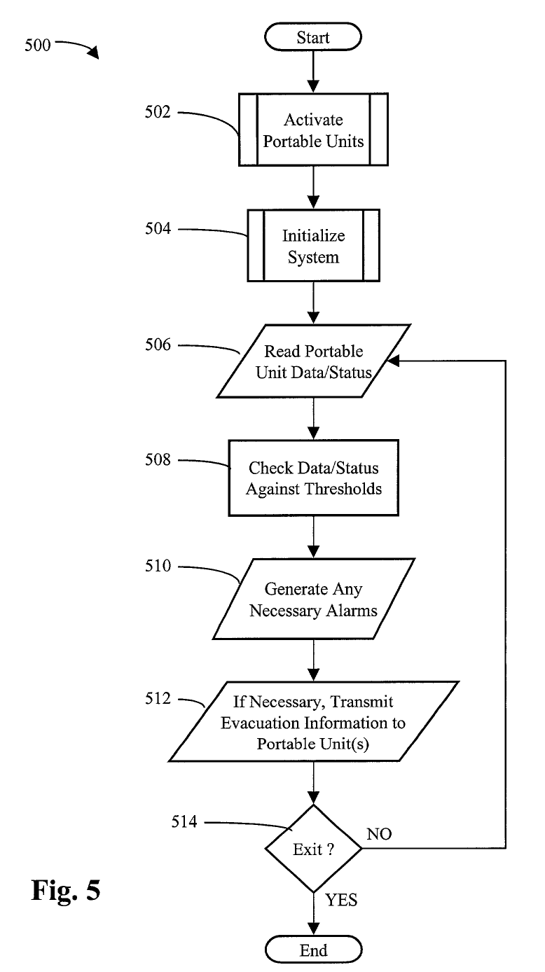

In operation, the command post system 102 and portable unit(s) 106 establish a master-slave relationship. More specifically, command post system 102 serves as a master and the portable units 106 serve as slaves. The command post system 102 communicates with the portable unit(s) 106 via a polling/retry communication architecture. More specifically, portable unit(s) 106 are required to respond to requests from the command post system 102. The system is made robust by a message protocol that requires message acknowledgment from each portable unit 106. If an acknowledgment is not received and understood by the command post system 102, the message is resent several times. After several attempts, the command post system 102 alerts that the portable unit 106 is out of range or malfunctioning. Additionally, each portable unit 106 expects to be contacted by the command post system 102 at regular time intervals. If a particular portable unit 106 is not contacted after a preset time has elapsed, the wearer or user of the portable unit 106 is alerted that the command post system 102 is out of range. In this manner, both ends of the communications link are alerted if the link is interrupted. Each portable unit 106 also has the ability to transmit certain emergency signals or information without a request from the command post system 102. These emergency signals or information are described in more detail in connection with FIGS. 4 and 5.

Where communication links are difficult to establish such as, for example, in large buildings and other massive structures, system 120 of FIG. 1B can be employed. System 120 is similar to system 100 of FIG. 1A, except that one or more repeater units 104 are employed to increase the range of communication between the portable unit(s) 106 and the command post system 102. For example, in large buildings where concrete, metal, or other materials can cause the range of communication between the portable unit(s) 106 and command post system 102 to be shortened, a repeater unit 104 can be used to transmit and receive signals between the portable unit(s) 106 and command post system 102. While only one repeater unit 104 is shown in FIG. 1B, multiple repeater units 104 can be employed depending on the desired or required range.

As an alternative to system 120 of FIG. 1B, system 130 of FIG. 1C has a repeater unit 104 associated with each portable unit 106. In this embodiment, repeater unit 104 and portable unit 106 preferably communicate with each other via a short-link RF signal system so as to eliminate any physically corded connections between the two units. A short-link RF signal system is desirable because it minimizes or eliminates the physical restraints and dangers introduced by corded systems. In an alternate embodiment, the repeater unit 104 and portable unit 106 can be integrated into a single unit with hardwire communication connections therebetween.

As a further alternative to the above embodiments, a system 140 that utilizes a packet-mode communication architecture to further expand the range communications between a port unit 106 and a command post system 102 is provided. More specifically, this packet-mode communication architecture is particularly useful when the link between the portable unit 106 and base station or command post system 102 has been interrupted. In this regard, the out of range portable unit 106 monitors it communication channel to determine if it can “hear” any other portable units thereon and whether those units are in communication with the command post system 102. If the out of range portable unit 106 find a portable unit 106A, which is in communication with command post system 102, it will communicate with that portable unit and use it as a relay to the command post system 102.

In general, the location of portable unit 106 and sensor system 108 can be anywhere on a person's body. Nevertheless, portable unit 106 is preferably attached or otherwise affixed to the SCBA 112 worn on a person's body. Alternatively, portable unit 106 and sensor system 108 can be affixed near the face of a user as when located on a protective face mask. Other locations include near the shoulder, chest, or on the arm.

As will be described in more detail in connection with FIG. 4A, the location of sensor system 108 depends on the particular parameter(s) the sensor system 108 is sensing. Generally, each sensor of sensor system 108 can have its own location on a person's body, depending on the parameter being sensed. It is preferable that, to the extent possible, sensor system 108 is integrated into portable unit 106 to reduce the number discrete components required. In this regard, communication between individual sensors and the sensor system 108 is preferably hardwired, though it can also be RF where hardwiring is physically restrictive or impractical.

In the case of repeater unit 104 being a discrete component of system 130, it is preferably worn a person's body at a location different from the portable unit 106 such as, for example, near a user's waist or hips. One important consideration in determining the locations for the repeater unit 104, portable unit 106 and sensor system 108 is that they should minimally interfere with the range of physical motion required by the individual wearing the system. For example,, a firefighter may have the portable unit 106 incorporated into a protective face mask and the repeater unit 104 attached to the waist or hip.

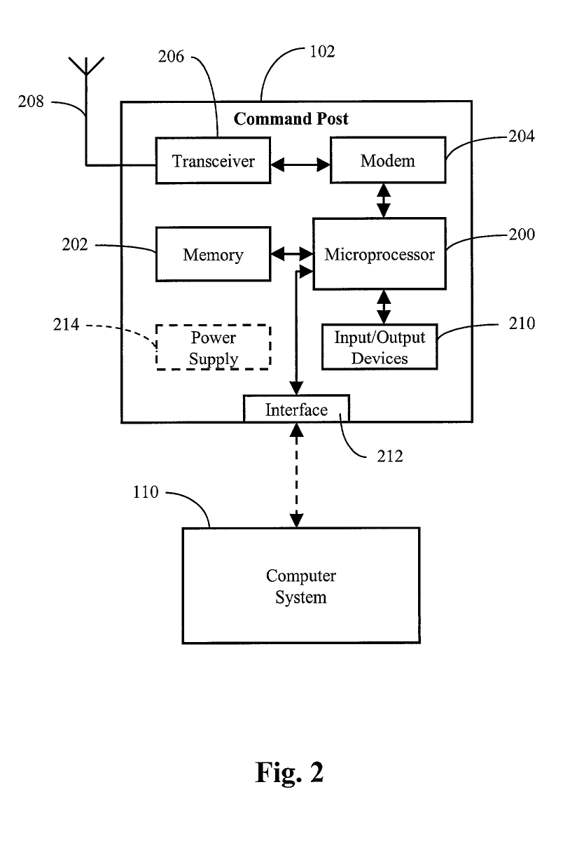

Referring now to FIG. 2, a block diagram illustrating the command post system 102 is shown. More specifically, the command post system 102 is enclosed in a weatherproof housing and has a microprocessor 200, memory 202, modem 204, transceiver 206, antenna 208, one or more input/output devices 210, and an interface 212, all in circuit communication as shown. As used herein, the term circuit communication means any form of electronic communication including hardwired, infrared, optical fibers, and/or electromagnetic.

The memory 202 preferably stores the programs or instructions responsible for directing the microprocessor's actions and all relevant data such as, for example, data collected from the portable unit(s) 106 and sensor system(s) 108. Memory 202 is preferably large enough to store approximately 8 or more hours of data acquired from the portable unit(s) 106 and sensor system(s) 108. Such data logging provides for comprehensive after-action reviews and documentation.

The modem 204 and transceiver 206, along with antenna 208, provide a two-way communication channel between the repeater unit(s) 104 and portable unit(s) 106. Information or data is preferably transmitted between the command post system 102 and the repeater unit(s) 104 and portable unit(s) 106 via Quadrature Phase-Shift Keying (QPSK) modulation. In the alternative, other modulation techniques can be employed including digital bandpass modulations such, as, for example, Amplitude Shift Keying (ASK), Frequency Shift Keying (FSK), Phase Shift Keying (PSK), Differential PSK, M-ary modulation, Offset QPSK, and Quadrature Amplitude Modulation (QAM).

Input/output devices 210 preferably provide the command post system 102 with local input and output capability. For example, input and output devices 210 can include indicator lights, displays such as, for example, Liquid Crystal Displays (LCD's) that can generate graphic and textual messages, microphone(s), speaker(s), keyboard(s) and push-buttons.

Interface 212 is preferably an RS-232 interface suitable for connection with the computer system 110. Computer system 110 provides additional functionality and memory to the commander of the command post system 102. For example, computer system 110 can display real-time video from one or more camera systems incorporated into sensor system(s) 108. Additional functionality includes the networking of data to remote computers via the Internet or other network and the ability delegate command tasks to commanders that are networked in other locations. A power supply 214 is provided to power all the components of the command post 102. The power supply 214 can be an internal battery and/or an external power supply such as, for example, an external AC or DC power source.

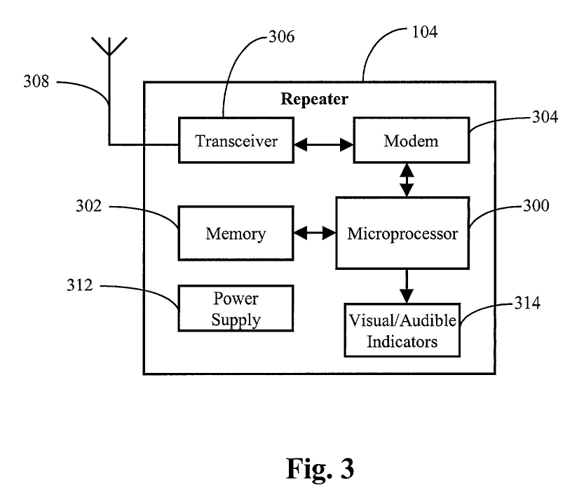

Referring now to FIG. 3, repeater unit 104 is shown in greater detail. The repeater unit 104 provides a high-power communications link between the relatively low-power portable unit 106 and the high-power command post system 102. Portable unit 106 is low-power only in the sense that it produces a signal strength that has a limited range. Nevertheless, the range should be large enough so that the command post system 102 or repeater unit 104 can reliably pick-up the signal.

The repeater unit 104 preferably includes a microprocessor 300, memory 302, modem 304, transceiver 306, visual/audible indicators 314, and antenna 308. The modem 304 and transceiver 306, along with antenna 308, provide a two-way communication channel with the command post system 102 and portable unit 106. The memory 302 is preferably flash upgradeable and stores the programs or instructions responsible for directing the microprocessor's actions and all relevant data such as, for example, data collected from the portable unit(s) 106 and sensor system(s) 108. Memory 302 is preferably large enough to store approximately 8 or more hours of data acquired from the portable unit(s) 106. Visual/audible indicators 314 preferably include lights and/or speakers that emit signals that assist in locating the repeater unit 104 such as, for example, when repeater unit 104 is a discrete component located somewhere in or near, for example, a building. An internal power supply 312 such as, for example, batteries, are provided to power the repeater unit 104.

Referring now to FIG. 4A, portable unit 106 and sensor system(s) 108 are shown in more detail. As described earlier, the portable unit 106 receives and sends data and information either directly to the command post system 102 or through repeater unit 104. Portable unit 106 preferably has a microprocessor or controller 400, memory 402, modem 404, transceiver 406, antenna 408, a plurality of input/output devices 412, an interface 416, and power supply 420. The portable unit 106 also includes an Analog-to-Digital (ADC) converter 418 that can be either integrated into microprocessor 400 or exist as a discrete component. ADC 418 allows for the input of analog data from sensor system(s) 108 for conversion into digital form. More generally, microprocessor 400 and other associated control circuitry are capable of accepting voice, data, and video signals and digitizing, buffering, and formatting such signals for transmission to the command post system 102 or repeater unit 104. Microprocessor 400 also includes a clock for time-marking incident data in memory 402. Incident data includes any status information sent to or received from command post 102.

Modem 404 and transceiver 406, along with antenna 408, provide a two-way communication channel between repeater unit 106 and command post system 102. Memory 402 is preferably flash upgradeable and stores the programs and instructions responsible for directing the microprocessor's actions and all relevant data such as, for example, data collected from portable unit(s) 106 and data received from the command post system 102. Memory 202 is preferably large enough to store approximately 8 or more hours of data acquired from the portable unit(s) 106 and command post system 102.

The input/output devices 412 preferably include status and message indicators that notify or alert the individual wearing the portable unit 106 of important status conditions and communications from the command post system 102. Such devices include, for example, switches, push-buttons, speakers, indicator lights such as built-in LED arrays, integrated visual and audible indicators that use combinations of the preceding. Visual indicators include multicolor LEDs, LED arrays, alphanumeric displays, micro-displays, back-lit LCD displays, and others. The displays can include means of sensing ambient light levels and adjusting display brightness levels accordingly. For example, when used in sunlight, the brightness would be greater and, when used in darkness, the brightness would be reduced. Such displays are preferably located for optimum viewing by the user. The input/output devices 412 also include an electronic key interface and/or bar code reader for reading an electronic key or bar code 448. The electronic key is preferably a non-volatile memory device that stores user information and identification data. Such devices include, for example, EEPROM's, smartcards and barcodes. The EEPROM and smartcard are electronic in nature and, store the data as series of binary numbers. These devices are user re-configurable and thus allow alterations of their contents. In the case of an EEPROM, it is preferably integral to a physical key device that is plugged into the portable unit to provide identification and personal information about the wearer. A smartcard-based system requires the user to insert the smartcard into an attached card reader, which would then read and transfer the user information to the portable unit. The smartcard can then be removed. A barcode based'system preferably scans a barcode worn by the user and transfers the data to the portable unit. The type of code utilized is preferably one of several alpha-numeric barcode standards. For example, common alpha-numeric barcodes are Code 39, Code 93, Code 128 and LOGMARS, which is a U.S. Government standard. In this, regard, barcode technology can be employed to generate codes that are linked to data tables in microprocessor 400 or memory 402 that include information identifying the individual assigned to the portable unit 106. The portable unit 106 also includes a Homing Signal generator 410, which will be described in connection with FIG. 5.

The interface 416 of portable unit 106 provides a communication link 422 between the portable unit 106 and any sensor system(s) 108 that may be provided. The communication link 422 can be either hardwired or RF depending on the particular sensor system. Preferable sensor systems(s) 108 include one more of the following systems: motion detector(s) 424, gas detector(s), Self Contained Breathing Apparatus (SCBA) status sensor 428, pressure sensor(s), a BLUETOOTH communications module 432, heads-up display 424, camera 436, microphone 438, speaker 440, temperature sensor 442, physiological sensor(s) 444, and a panic button 446.

The motion detector 424 aids the command post system 102 and portable 106 to monitor whether the individual wearing the portable unit 106 has been motionless for a preset period of time, thereby indicating a possible critical condition. The gas detector(s) 426 aid the command post system 102 and portable 106 to monitor the presence and levels of hazardous environmental gases such as for example, methane or other explosive gases. The SCBA status sensor aids the command post system 102 and portable 106 to monitor, for example, the amount of breathing gas or time remaining in the SCBA. The pressure sensor 430 aids the command post system 102 and portable 106 to monitor the pressure in, for example, the SCBA or the external environment. The BLUETOOTH module 432 provides a short range RF communication channel either directly from the sensor system(s) 108 or from the portable unit 106 to other digital devices such as, for example, digital cell phones and personal digital assistants (PDA). The heads-up display 434 provides the individual wearing the sensor system 108 with an intelligent display that allows graphics and text to be displayed over a transparent window. The transparent window allows the wearer of the head-up display 434 to see messages thereon such as, for example, status information (e.g., temperature, remaining air, etc.) and alarms (e.g., evacuate now), while allowing the present environment to be seen. Information from the command post system 102 and/or portable unit 106 may also be displayed on the heads-up display 434. Camera 436 provides a video signal as directed by the wearer of the sensor system 108 to command post system 102. Camera 436 may be infrared, color, black and white, or any combination of the above. Microphone 438 and speaker 440 provide audible signals both to and from the wearer of the sensor system 108 to and from the command post system 102 and, optionally, to other team members who are wearing similar systems. Temperature sensor 442 monitors the environmental temperature and relays such information to the command post system 102. Physiological sensor(s) 444 monitor the wearer's physiological parameters such as, for example, blood pressure, body temperature, heart rate, blood oxygen level, galvanic skin response, and brain activity. Information gathered from such physiological sensors is relayed to the command post system 102 for monitoring by a commander or medical professional. A panic button 446 is also provided so the wearer of the sensor system 108 can initiate a panic call to the command post system 102 and await instructions therefrom via the system's speaker 440.

In addition to the above sensor system(s) 108, the portable unit 106 can include an external audible system. The external audible system preferably includes a speech synthesis chip or system for connection via an external data port to speaker(s) 440. When speaker(s) 440 include an external speaker, spoken status updates and/or alarms can be audibly broadcast over the speaker. For example, the remaining air levels in the SCBA tank, temperature levels, and evacuation alarms can all be broadcast using synthesized speech to the user. The portable unit 106 microprocessor 400 executes commands that provide for such functionality.

Illustrated in FIG. 4B is a diagram illustrating a the general location of portable unit 106 and sensor system 108 of the present invention in relation to a SCBA 112. More specifically, a typical SCBA 112 has a portable breathing gas tank 448, mask 454 and tubing 452 connecting the two components. Breathing gas tank 448 has a removable fitting 450 from which breathing gases can exit and to which tubing 452 can interface. Portable unit 106 and sensor system 108 are preferably affixed to SCBA 112 at or near fitting 450. In this manner, pressure sensor 430 and SCBA status sensor 429 (shown in FIG. 4A) can be located on or near the breathing gas tank 448. This arrangement facilitates convenient pressure measurement of breathing gas tank 448. This arrangement also maintains the mechanical integrity of breathing gas tank 448 by not requiring any additional interfaces to monitor the status thereof such as, for example, pressure.

Referring now to FIG. 5, the operation of the present invention will be described in more detail. More specifically, FIG. 5 illustrates a flowchart 500 of the steps performed by the system of the present invention. In step 502, independent of the command post system 102, the portable unit(s) 106 can be automatically activated with pressurization of the SCBA or manually activated if an SCBA is not used. The logic next proceeds to step 504 where a series of sub-steps that initialize the system are performed. In particular, the command post system 102 transmits a request for any active portable unit 106 to respond. All active portables units 106 respond to the command post system 102 request with their unique address and other data if available such as, for example, user name and medical information. Portable units 106 use synthesized radio transceivers that allow the portable unit 106 particular radio frequency to be programmed via software in the memory of each portable unit 106.

Active portable units 106 can be manually accepted or rejected by the commander using the command post system 102. As the portable units 106 respond, the command post system 102 builds a connectivity list of all active portable units 106 accepted by the incident commander. Because each portable unit 106 has a unique address, more than one accountability system (e.g., system 100, 120, or 130) of the present invention can operate in the same area. This is possible because the RF of each portable unit 106 is programmable via software and can be easily changed from command post system 102. Hence, command post system 102 has ability to accept or reject particular portable units 106 in defining it command responsibilities.

Once all of the portable units 106 have been logged into the command post system 102, operation progresses to step 506 where the system enters a monitoring/command mode. In this mode, the command post system 102 transmits queries to portable units 106 requesting status or data updates. Upon receipt of a query, a portable unit 106 transmits a status update to the command post system 102. This data is preferably related to the above described sensor system(s) 108. In step 508, microprocessor 400 in the portable unit 106, or alternatively, microprocessor 200 in the command post system 102, checks the data against thresholds to determine if any alarms should be generated. In step 510, if data from a portable unit 106 is above or below preset thresholds, this condition is flagged as an alarm condition at the command post system 102 with both an audible and a visual alert. Upon receiving an alarm, the commander can activate the portable unit 106 homing signal function so that a rescue team can enter the building and find the affected user.

Under certain other conditions, a commander may want to evacuate an individual, a team, or everyone in an emergency situation. This condition is represented in step 512. For example, if a firefighter's air is low as indicated by his SCBA status sensor 428, the commander may choose to evacuate the individual. If a building's roof is in danger of imminent collapse, a commander may choose to issue a general evacuation call to all firefighters. Using the command post system 102, the commander may direct an “evacuate now” message to the designated individual or group. The message can take the form of an audio signal on the user's speaker 440, a message on the user's heads-up display, a visual signal such as a flashing red light on the portable unit 106, or combinations of the above.

Users can notify the command post system 102 that they've safely evacuated a building with a Respond/Clear button on the portable unit 106, which would be read in received in step 506. This allows a commander to keep track of those individuals who have received the evacuation alert and have safely exited the area and those that have not exited. Armed with this knowledge, the commander can activate the homing signal of any remaining users and mount a search effort for those individuals.

As previously described, the portable units 106 can transmit certain alarm messages without a query from the command post system 102. These messages include a “distress alarm,” which can be manually activated in the event of emergency. Additional alarm messages include a Personal Alert Safety System (PASS) alarm that is automatically generated by the portable unit 106 if the sensor system 108 motion detector 424 does not sense motion for a preset period of time.

In the event that a Not Acknowledge (NAK) signal or no signal is received in response to a query to a portable unit 106, command post system 102 will re-send the query a specified number of times. After the number of tries (the number is software configurable) has expired, the command post system 102 generates an “Out of Range” alert for the portable unit(s) 106 not responding to the query. Additionally, a portable unit 106 that does not receive a query from the command post system 102 for specified period of time will report via an audible and/or visual “Out of Range” alert to the user of the portable unit 106.

As described above, portable units 106 send status updates upon receipt of a query from the command post system 102. The type of status updates or queries preferably depend on the number and type of peripherals or sensor system(s) 108 attached to the portable unit 106. For example, if a self-contained breathing apparatus (SCBA) status sensor and a temperature sensor are connected, portable unit 106 transmits the latest air pressure in the tank of the SCBA and the latest environmental temperature. In this regard, the command post system 102 polls each active portable unit 106 on a regular basis to receive status or data updates.

In order to increase the robustness of the system, the command post system 102 can receive emergency messages from portable units 106 that are not logged onto the system's original log table. This ensures that a user's emergency signal can be received by any and all command post systems 102 that are in the vicinity or locality. Also in this regard, the command post system 102 can send general messages such as “evacuate all” to all portable units 106, including units not logged into the system.

Personnel location is determined in the Monitoring/Command mode via a homing function. More specifically, each portable unit 106 includes electronics to help a rescue team locate the user. These electronics are primarily embodied in the homing signal generator 410. A homing beacon or signal in the portable unit 106 is activated either automatically or remotely from the command post system 102. Upon receipt of a distress alarm from a portable unit 106, a commander can activate the portable unit 106 homing signal generator 410. A rescue team using a locate device having a directional antenna, Radio Signal Strength Indicator (RSSI) and readout could locate the individual by moving toward the portable unit 106 homing signal.

The system of the present invention may either alternatively, or additionally, incorporate other technologies that assist in locating a person in distress. For example, the portable unit 106 of the present invention can incorporate an altimeter and a “dead reckoning” system. Such a system creates a directional trail (i.e., distance traveled, direction traveled, height (e.g., which floor) or number and type of steps taken), that a rescue team could follow to locate and extract an individual. The system may further incorporate a Global Positioning System (GPS) in the portable unit 106, which is particularly useful for locating individuals in outdoor situations.

Still referring to FIG. 5, operation of the present invention continuously loops in the monitoring/command mode of operation until an exit is desired, as determined in step 514. For example, the system exits the monitor/command mode when it is desired to shut-down the system. Otherwise, the system loops back to step 506.

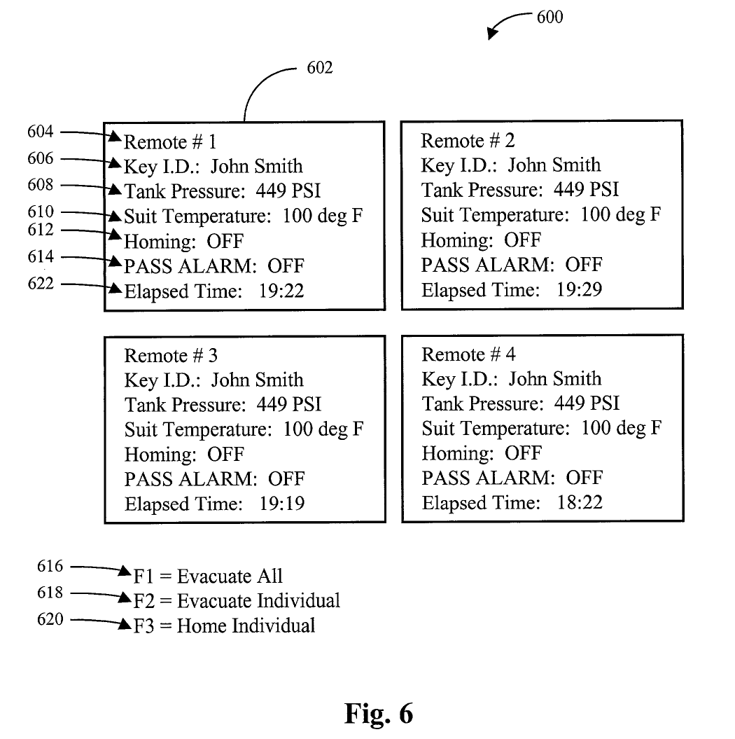

Referring now to FIG. 6, a portion 600 of a display that can be generated by the command post system 102 or computer system 110 is shown. The portion 600 includes at least one portable unit information area 602 that displays status information from a portable unit 106 that is logged into the command post system 106. The area 602 includes a remote identification number 604, key identification 606, and sensor system status information such as, for example, tank pressure 608 and suit temperature 610. The area 602 also includes a “Homing” status indication 612, PASS alarm status indication 614, and elapsed time meter 622. The “Homing” status 612 indicates if the portable unit 106 homing signal function has been activated. Similarly, the PASS alarm status 614 indicates if the PASS alarm has been activated. In general, any information provided by any sensor system 108 in communication with portable unit 106 can be displayed in area 602 including, for example, video from camera 436 and physiological data from physiological sensor(s) 444.

Display portion 600 also allows a commander to see the list of portable units 106 that are logged onto the command post system 102, individual or team status information, elapsed time 622, and out of range alerts for any portable unit (when appropriate.) Alarm conditions are flagged visually and audibly. For example, an alarm condition can be represented as an audible signal and a text message that is colored red and flashing on the display. Normal conditions are preferably displayed in green color. Other color combinations are possible, but the color combination of red and green are the most universally understood to mean alarm and condition clear, respectively.

As described earlier, a commander can transmit evacuation messages to individuals, teams or, all portable units 106. In this regard, display portion 600 includes visible instructions on how these functions are initiated. For example, display portion 600 includes an “Evacuate All” instruction 616 that directs depression of an “F1” key or button for initiation of the function. Similarly, display portion 600 includes “Evacuate Individual” and “Home Individual” instructions 618 and 620, respectively, that direct depression of the “F2” and “F3” keys or buttons, respectively, to initiate such functions. Individuals or portable units 106 that have responded to the evacuation signal and have cleared the area can acknowledge so and their status will be reported on the command post system 102 and/or computer system 110. Messages in this regard are displayed in the appropriate portable unit information area 602.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, the constituents of the command post system, portable unit, and sensor system can be varied and still obtain the functionality and structure described herein. Additionally, the system communication and control approach can be varied while still maintaining a robust communications architecture. Moreover, the location of various components of the present invention can be modified without affecting their function and purpose. Therefore, the invention, in its broader aspects, is not limited to the specific details, the representative apparatus, and illustrative examples shown and described. Accordingly, departures can be made from such details without departing from the spirit or scope of the applicant's general inventive concept.

We claim:

1. A communication module for use in an accountability system having a two-way communication channel with a command post, said module comprising:
(a) an electronic key port configured to accept an electronic key device having identification information;
(b) at least one sensor port for interfacing with at least one sensor system;
(c) a controller in circuit communication with said electronic key port and said at least one sensor port and having:
(1) logic for reading and storing said identification information;
(2) logic for transmitting said identification information to said command post; and
(3) logic for transmitting data received through said sensor port to said command post; and
(c) a modem in circuit communication with said controller; and
(d) a radio transceiver in circuit communication with said modem.

2. The module of claim 1 wherein said controller further comprises logic for sensing a disruption in said two-way communication channel and for providing an alert at based thereon.

3. The module of claim 1 wherein said controller further comprises logic transmitting a continuous radio-frequency homing signal in the event of an emergency that can be used to locate said communication module by a rescue team.

4. The module of claim 1 wherein said controller is affixed to a self-contained breathing apparatus (SCBA) and further comprises logic for automatic activation when said SCBA is pressurized.

5. The module of claim 1 further comprising a panic button and said controller further comprising logic for transmitting a distress signal to said command post upon actuation of said panic button.

6. The module of claim 1 further comprising an acknowledge button and said controller further comprising logic for transmitting an acknowledge signal to said command post upon actuation of said acknowledge button.

7. The module of claim 1 wherein said controller further comprising logic for comparing data received through said sensor port to alarm condition thresholds.

8. The module of claim 1 wherein said module further comprising at least one visual alarm indicator and said controller further comprising logic for activating said at least one visual alarm indicator.

9. The module of claim 1 wherein said module further comprising at least one audio alarm indicator and said controller further comprising logic for activating said at least one audio alarm indicator.

10. The module oaf claim 1 further comprising a clock and said controller further comprising logic for logging clock data and incident data for subsequent retrieval.

11. The module of claim 1 wherein said identification information comprises name and medical history information.

12. The module of claim 1 wherein said sensor system comprises a pressure sensor configured to sense a self-contained breathing apparatus pressure.

13. The module of claim 1 wherein said sensor system comprises a video camera.

14. The module of claim 1 wherein said sensor system comprises a motion sensor.

15. The module of claim 1 further comprising an audio speaker.

16. The module of claim 1 further comprising a BlueTooth communications module.

17. The module of claim 1 wherein said sensor system comprises an environmental gas detector.

18. The module of claim 12 wherein said sensor system comprises at least one physiological sensor.

19. The module of claim 12 wherein said sensor system comprises an external temperature sensor.

20. An accountability system for rescue personal comprising:
(a) at least one command post comprising:
(1) a command post controller;
(2) a command post modem in circuit communication with said command post controller; and
(3) a command post transceiver in circuit communication with said command post modem;
(b) at least one portable remote communication module comprising:
(1) an electronic key port configured to accept an electronic key device having identification information;
(2) at least one sensor port for interfacing with at least one sensor system;
(3) a remote communication module controller in circuit communication with said electronic key port and having:
(i) logic for reading and storing said identification information; and
(ii) logic for transmitting said identification information to said command post;
(iii) logic for transmitting data received through said sensor port to said command post;
(4) a remote communication module modem in circuit communication with said remote communication module controller; and
(5) a remote communication module transceiver in circuit communication with said remote communication module modem; and
(c) a sensor system in circuit communication with said sensor port and comprising a pressure sensor for sensing pressure from a self-contained breathing apparatus.

21. The system of claim 20 further wherein said command post further comprises logic for activating a homing signal in said at least one portable remote communication module to facilitate location by a rescue team.

22. The system of claim 20 wherein said command post further comprises a display and logic for displaying real-time status information received from said at least one portable remote communication module.

23. The system of claim 20 wherein said command post further comprises a memory for storing data sent to and received from said at least one portable remote communication module.

24. The system of claim 20 wherein said sensor system comprises a pressure sensor configured to sense a self-contained breathing apparatus pressure.

25. The system of claim 20 wherein said sensor system comprises a video camera.

26. The system of claim 20 wherein said sensor system comprises a motion sensor.

27. The system of claim 20 wherein said at least one portable remote communication module comprises an audio speaker.

28. The system of claim 20 wherein said at least one portable remote communication module comprises a BlueTooth communications module.

29. The system of claim 20 wherein said sensor system comprises an environmental gas detector.

30. The system of claim 20 wherein said sensor system comprises at least one physiological sensor.

31. The system of claim 20 wherein said sensor system comprises an external temperature sensor.

32. A self-contained breathing apparatus comprising:
(a) a mask;
(b) a breathing gas tank in fluid communication with said mask; and
(c) a communication module comprising:
(1) an electronic key port configured to accept an electronic key device having identification information;
(2) at least one sensor port for interfacing with at least one sensor system;
(3) a controller in circuit communication with said electronic key port and having:
(i) logic for reading and storing said identification information; and
(ii) logic for transmitting said identification information to a command post; and
(iii) logic for transmitting data received through said sensor port to said command post; and
(d) said sensor system comprising a pressure sensor for sensing pressure from said breathing gas tank.
